(19) United States
(12) Patent Application Publication
(10) Pub. No.: US 2019/0023200 A1
(43) Pub. Date: Jan. 24, 2019

(54) ROLL CONNECTOR

(71) Applicant: KABUSHIKI KAISHA TOKAI RIKA DENKI SEISAKUSHO, Aichi (JP)

(72) Inventor: Keiji MURASE, Aichi (JP)

(21) Appl. No.: 16/070,775

(22) PCT Filed: Feb. 28, 2017
(86) PCT No.: PCT/JP2017/007774

§ 371 Date: Jul. 17, 2018

(30) Foreign Application Priority Data
Mar. 2, 2016 (JP) 2016-040164

(51) Int. Cl. B60R 16/027; G02B 6/42; H04B 10/80

(52) U.S. Cl. CPC B60R 16/027; B62D 15/021; H04B 10/80; G02B 6/42

(57) ABSTRACT

A roll connector is provided with: a light-emitting body and a light-receiving body, the roll connector communicates data between the fixed part and the rotating part by optical communication of the light-emitting body and the light-receiving body; angle sensors provided to the fixed part and/or the rotating part and detecting a relative rotation angle; and a control unit for determining, on the basis of a received optical signal, the data included in the received optical signal. The control unit executes at least one of: changing, according to the relative rotation angle, the data information compared with the received optical signal; correcting the quantity of radiated light according to the relative rotation angle so that the quantity of received light is constant; and correcting the signal level of the received optical signal according to the relative rotation angle so that the signal level of the received optical signal is constant.

### TECHNICAL FIELD

The present invention relates to a roll connector.

### BACKGROUND ART

A roll connector known in the art enables transmission and reception of a signal between a steering column and a steering wheel while allowing for rotation of the steering wheel relative to the steering column. Patent document 1 describes a roll connector in which a light-emitting element and a light guide (steering column light guide) are arranged on a fixed part of the steering column, and a light-emitting element and a light guide (steering wheel light guide) are arranged on a rotating part of the steering wheel. The two light guides of the roll connector reflect light emitted from the light-emitting elements and guide the light to light-receiving elements. The roll connector performs optical communication with the two light guides to enable transmission and reception of a signal between the steering column and the steering wheel.

### PRIOR ART DOCUMENT

### Patent Document

Patent Document 1: Japanese Laid-Open Patent Publication No. 2003-241003

### SUMMARY OF THE INVENTION

In the roll connector, operation on the steering wheel changes the positional relationship of the light-emitting element and the light guide (steering wheel light guide). This changes the angle of the incident light from the light-emitting element at the light guide (steering wheel light guide). Thus, the angle of light received from the light-receiving element by the light guide (steering column light guide) also changes. This will vary the amount of the light received by the light-receiving element. When the amount of the light received by the light-receiving element is small, data transmitted from the steering wheel to the steering column may not be correctly recognized.

It is an object of the present invention to provide a roll connector in which the transmission accuracy of data is high.

One aspect of the present invention is a roll connector including a fixed part, a rotating part, a light emitter, a light receiver, an angle sensor, and a controller. The rotating part rotates relative to the fixed part. The light emitter is arranged on one of the fixed part and the rotating part. The light emitter emits light. The light receiver is arranged on the other one of the fixed part and the rotating part. The light receiver can receive light from the light emitter. The roll connector communicates data between the fixed part and the rotating part through optical communication with the light emitter and the light receiver. The angle sensor is arranged on at least one of the fixed part and the rotating part. The angle sensor detects a relative rotation angle of the rotating part relative to the fixed part. The controller determines data included in a light-receiving signal converted from light by the light receiver. When determining the data included in the light-receiving signal, the controller is configured to execute at least one of changing data information that is compared with the light-receiving signal in accordance with the relative rotation angle, correcting an amount of light emitted by the light emitter in accordance with the relative rotation angle so that an amount of light received by the light receiver is fixed independently from the relative rotation angle, and correcting a signal level of the light-receiving signal in accordance with the relative rotation angle so that the signal level of the light-receiving signal is fixed independently from the relative rotation angle.

With this structure, regardless of the positional relationship of the light emitter and the light receiver, the condition for determining data included in the light-receiving signal is constant. This allows the controller to correctly recognize the data included in the light-receiving signal easily. Consequently, the transmission accuracy of data through optical communication is high.

The roll connector of the present invention has the advantage in which the transmission accuracy of data is high. Other embodiments and advantages of the present invention are understood from the following description together with the drawings that illustrate the examples of technical ideas of the present invention.

### BRIEF DESCRIPTION OF THE DRAWINGS

FIG. 1 is a perspective view showing one embodiment of a roll connector.

FIG. 2 is a block diagram illustrating a communication mode of the roll connector.

### EMBODIMENTS OF THE INVENTION

One embodiment of a roll connector applied to a steering roll connector will now be described with reference to the drawings.

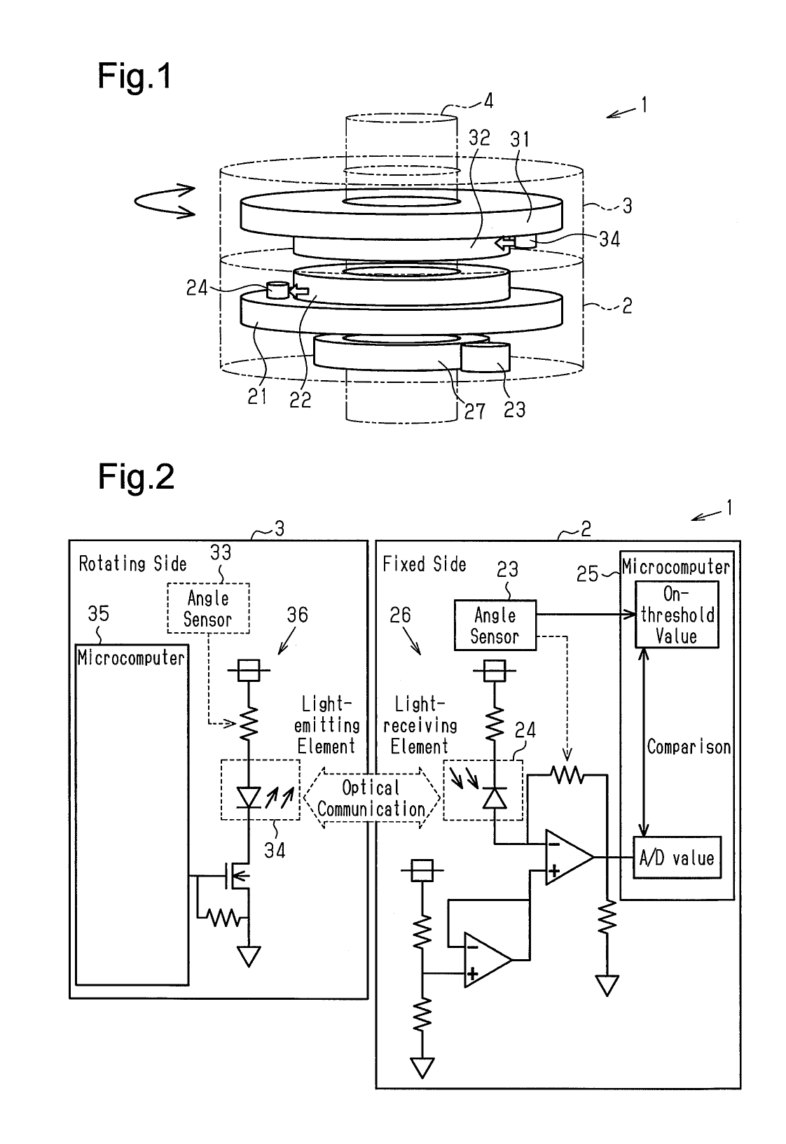

As shown in FIG. 1, a steering roll connector 1 includes a fixed case 2 and a rotating case 3. A common steering shaft 4 is inserted through the fixed case 2 and the rotating case 3. The rotating case 3 is rotatable relative to the fixed case 2.

The rotating case 3 accommodates a rotating plate 31 and a rotating-side light guide 32.

A central portion of the rotating plate 31 includes an engagement hole through which the steering shaft 4 is inserted and with which the steering shaft 4 is engaged and rotated integrally. The rotating plate 31 is fixed to the inner side of the rotating case 3 by an engagement relationship (not shown). The rotating-side light guide 32, which is annular, and a light-emitting element 34 are coupled to the surface of the rotating plate 31 facing the fixed case 2. The light-emitting element 34 is located adjacent to the rotating-side light guide 32.

The light-emitting element 34 emits light to the rotating-side light guide 32. The rotating-side light guide 32 guides the light received from the light-emitting element 34 to a fixed-side light guide 22 (described later). As shown in FIG. 2, the rotating case 3 further accommodates a rotating-side microcomputer 35 and a light-emitting circuit 36 controlled by the rotating-side microcomputer 35. The light-emitting element 34 is arranged on the rotating plate 31 and connected to the light-emitting circuit 36. That is, the emitting mode of the light-emitting element 34 is controlled by the rotating-side microcomputer 35. The rotating plate 31 corresponds to a fixed part, and the light-emitting element 34 corresponds to a light emitter.

As shown in FIG. 1, the fixed case 2 accommodates a fixed plate 21, the fixed-side light guide 22, and an angle sensor 23.

A central portion of the fixed plate 21 includes a through hole through which the steering shaft 4 is inserted. The fixed plate 21 is fixed to the inner side of the fixed case 2 by an engagement relationship (not shown). The fixed-side light guide 22, which is annular, and a light-receiving element 24 are coupled to the surface of the fixed plate 21 facing the rotating case 3. The light-receiving element 24 is located adjacent to the fixed-side light guide 22. The fixed-side light guide 22 receives light from the rotating-side light guide 32 and guides the light to the light-receiving element 24.

Referring to FIG. 2, the light-receiving element 24 is a semiconductor device that excites current with the light emitted from the light-emitting element 34 and generates a light-receiving signal indicating the amount of light received. The fixed case 2 further accommodates a fixed-side microcomputer 25 and a light-receiving circuit 26 that is electrically connected to the fixed-side microcomputer 25. The light-receiving element 24 is arranged on the fixed plate 21 and connected to the light-receiving circuit 26. The light-receiving element 24 converts light into a light-receiving signal, which is an electric signal, and transmits the light-receiving signal to the fixed-side microcomputer 25 via the light-receiving circuit 26. The fixed plate 21 corresponds to a fixed part, and the light-receiving element 24 corresponds to a light receiver. Further, the fixed-side microcomputer 25 corresponds to a controller.

As shown in FIG. 1, the fixed case 2 further accommodates a magnetic body 27 coupled to the steering shaft 4. The magnetic body 27 is, for example, annular. The angle sensor 23 is, for example, of a magnetic-detection type configured by a Hall IC or the like. In the same manner as the fixed plate 21, the angle sensor 23 is fixed to the inside of the fixed case 2 by an engagement relationship (not shown) at a position proximate to the magnetic body 27. The angle sensor 23 detects a rotation angle of the steering shaft 4 from a change in a magnetic field formed by the magnetic body 27, which rotates integrally with the steering shaft 4. The angle sensor 23 is electrically connected to the fixed-side microcomputer 25, which is arranged on the fixed plate 21, and transmits detected rotation angle information of the steering shaft 4 to the fixed-side microcomputer 25.

The fixed-side microcomputer 25 includes a memory 25a storing a plurality of ON-threshold values that are compared with light-receiving signals received from the light-receiving circuit 26. The ON-threshold values correspond to data information. Each ON-threshold value corresponds to a rotation angle of the steering shaft 4. The fixed-side microcomputer 25 sets a suitable ON-threshold value from the ON-threshold values based on the rotation angle information of the steering shaft 4 transmitted from the angle sensor 23. The fixed-side microcomputer 25 compares the set ON-threshold value with an A/D value of a light-receiving signal received from the light-receiving circuit 26. The fixed-side microcomputer 25 determines from the comparison result that the light-receiving signal has been transmitted from the rotating-side microcomputer 35 through optical communication and controls various onboard devices in accordance with data that is based on the light-receiving signal.

The operation and advantage of the steering roll connector 1 will now be described. The transmission of data with light is known in the art and thus will not be described.

Relative rotation of the fixed case 2 and the rotating case 3 relatively rotates the light guide 22 and the light guide 32. Thus, the angle of light entering the light guide 22 from the light guide 32 changes in accordance with the relative rotation angle of the fixed case 2 and the rotating case 3. Further, the angle of light entering the light-receiving element 24 from the light guide 22 changes in accordance with the relative rotation angle of the fixed case 2 and the rotating case 3. Accordingly, when the light-emitting element 34 performs optical communication with the same amount of light, a different amount of light reaches the light-receiving element 24 and varies the signal levels of light-receiving signals converted by the light-receiving element 24.

The fixed-side microcomputer 25 receives relative rotation angle information of the fixed case 2 and the rotating case 3 from the angle sensor 23, which is located in the fixed case 2, and sets a suitable ON-threshold value for a light-receiving signal from a plurality of ON-threshold values based on the relative rotation angle information. This allows the fixed-side microcomputer 25 to compare an A/D value of a light-receiving signal with the ON-threshold value suitable for the light-receiving signal and correctly recognize the data transmitted by the rotating-side microcomputer 35 through optical communication. Thus, even if the amount of light received by the light-receiving element 24 varies in accordance with the relative rotation angle of the fixed case 2 and the rotating case 3, the fixed-side microcomputer 25 controls various onboard devices based on correct data.

The steering roll connector 1 employs the angle sensor 23 of a magnetic-detection type. The magnetic field detected by the angle sensor 23 has no effect on the optical communication in which light reaches the light-receiving element 24 from the light-emitting element 34 via the light guides 22 and 32. Thus, data is transmitted in a preferred manner through optical communication from the rotating-side microcomputer 35 to the fixed-side microcomputer 25.

Further, the angle sensor 23 is spaced apart from the steering shaft 4 and thus has no effect on the rotation of the steering shaft 4. Thus, the steering shaft 4 has good rotating characteristics.

The above embodiment may be modified as described below.

In the above embodiment, the fixed-side microcomputer 25 changes an ON-threshold value, which is compared with an A/D value of a light-receiving signal, in accordance with a relative rotation angle detected by the angle sensor 23. Instead, the fixed-side microcomputer 25 may be configured as described below.

As shown by the broken lines in FIG. 2, the light-receiving circuit 26 may receive an electric signal indicating a relative rotation angle detected by the angle sensor 23 and adjust the signal level of a light-receiving signal to be constantly fixed in accordance with the electric signal independently from the relative rotation angle. In this case, the memory 25a of the fixed-side microcomputer 25 only needs to store a single ON-threshold value.

Further, as shown by the broken lines in FIG. 2, the rotating case 3 may include an angle sensor 33 instead of the angle sensor 23. In this case, the light-emitting circuit 36 may receive an electric signal indicating relative rotation angle information detected by the angle sensor 33 and adjust the amount of light emitted from the light-emitting element 34 so that the amount of light received by the light-receiving element 24 is constantly fixed. In this case, the memory 25a of the fixed-side microcomputer 25 only needs to store a single ON-threshold value.

Such a configuration obtains the same advantages as the above embodiment.

The above embodiment is applied to the steering roll connector 1 in which the fixed case 2 and the rotating case 3 are relatively rotatable in an axial direction of the steering shaft 4 but may be applied to a steering roll connector in which the rotating case 3 rotates inside the fixed case 2.

In the above embodiment, the light-receiving element 24 is exemplified as a semiconductor device. However, the light-receiving element 24 may be any device that induces current (light-receiving signal) when light is emitted.

In the above embodiment, the light guides 22 and 32 may be omitted. However, when the light guides 22 and 32 are omitted, the relative rotation angle of the light-emitting element 34 and the light-receiving element 24 greatly varies the amount of light received by the light-receiving element 24. Thus, it is preferred that ON-threshold values stored in the memory of the fixed-side microcomputer 25 be set in accordance with finer relative rotation angles.

In the above embodiment, the angle sensor 23 is of a magnetic-detection type. However, as long as the angle sensor 23 detects a relative rotation angle of the fixed case 2 and the rotating case 3 and consequently detects a relative rotation angle of the light-emitting element 34 and the light-receiving element 24, any detection method may be used.

In the above embodiment, the light emitter is arranged in the rotating case, and the light receiver is arranged in the fixed case. However, this relationship may be reversed. That is, the light receiver may be arranged in the rotating case, and the light emitter may be arranged in the fixed case.

In addition to a real vehicle, the steering roll connector of the above embodiment may be used in, for example, a driving game in which a vehicle shown on a display is driven.

The above embodiment is one embodiment of the roll connector applied to the steering roll connector. However, the roll connecter does not have to be applied as a steering roll connector.

It will be apparent to those skilled in the art that the present invention may be embodied in other specific forms without departing from the technical spirit thereof. For example, some of the components described in the embodiment (or one or more aspects thereof) may be omitted, or some of the components may be combined. The scope of the invention should be determined with reference to the appended claims along with the full scope of equivalents to which the appended claims are entitled.

### DESCRIPTION OF REFERENCE CHARACTERS

1: steering roll connector; 2) fixed case; 3) rotating case; 4) steering shaft; 21) fixed plate; 22, 32) light guide; 23, 33) angle sensor; 24) light-receiving element; 25, 35) microcomputer; 26) light-receiving circuit; 27) magnetic body; 31) rotating plate; 34) light-emitting element; 36) light-emitting circuit

1. A roll connector comprising:
a fixed part;
a rotating part that rotates relative to the fixed part;
a light emitter arranged on one of the fixed part and the rotating part, wherein the light emitter emits light;
a light receiver arranged on the other one of the fixed part and the rotating part, wherein the light receiver can receive light from the light emitter, wherein the roll connector communicates data between the fixed part and the rotating part through optical communication with the light emitter and the light receiver;
an angle sensor arranged on at least one of the fixed part and the rotating part, wherein the angle sensor detects a relative rotation angle of the rotating part relative to the fixed part; and
a controller that determines data included in a light-receiving signal converted from light by the light receiver, wherein when determining the data included in the light-receiving signal, the controller is configured to execute at least one of:
changing data information that is compared with the light-receiving signal in accordance with the relative rotation angle;
correcting an amount of light emitted by the light emitter in accordance with the relative rotation angle so that an amount of light received by the light receiver is fixed independently from the relative rotation angle; and
correcting a signal level of the light-receiving signal in accordance with the relative rotation angle so that the signal level of the light-receiving signal is fixed independently from the relative rotation angle.

2. The roll connector according to claim 1, further comprising a magnetic body arranged on one of the fixed part and the rotating part, wherein
the angle sensor is arranged on the other one of the fixed part and the rotating part and is of a magnetic-detection type that detects a magnetic field formed by the magnetic body.

3. The roll connector according to claim 1, further comprising a light guide that guides light between the light emitter and the light receiver.
